(19) United States
(12) Patent Application Publication
(10) Pub. No.: US 2012/0011358 A1
(43) Pub. Date: Jan. 12, 2012

(54) REMOTE ADMINISTRATION AND DELEGATION RIGHTS IN A CLOUD-BASED COMPUTING DEVICE

(75) Inventor: Christopher Masone, Burlingame, CA (US)

(73) Assignee: GOOGLE INC., Mountain View, CA (US)

(21) Appl. No.: 12/828,085

(22) Filed: Jun. 30, 2010

Related U.S. Application Data
(60) Provisional application No. 61/251,292, filed on Oct. 13, 2009.

(51) Int. Cl. G06F 15/173; H04L 9/00

(52) U.S. Cl. 713/153; 709/225

(57) ABSTRACT

Methods and apparatus for providing remote administration and delegation rights for a computing system are disclosed. An example method for facilitating remote administration of a first computing device includes receiving, by a second computing device, an administrator name and a username for a user account for a cloud-based computing service, where the user account is assigned to a user of the first computing device. The example method further includes transmitting, from the second computing device to a server, the username for the user account and the administrator name and receiving, by the second computing device, a control panel transmitted from the server, where the control panel accepting inputs to change user preferences for the user account and system settings for the first computing device. The example method also includes receiving, by the second computing device, an input from the control panel to change at least a user preference for the user account and transmitting, from the second computing device to the server, the changed user preference.

### CROSS-REFERENCE TO RELATED APPLICATIONS

This application claims the benefit, under 35 U.S.C. §119(e), of U.S. Provisional Patent Application Ser. No. 61/251,292, filed on Oct. 13, 2009. The disclosure of U.S. Provisional Patent Application Ser. No. 61/251,292 is incorporated by reference herein in its entirety.

### TECHNICAL FIELD

This application relates in general, to remote administration and delegation rights for cloud-based computers.

### BACKGROUND

With the creation of the World-Wide-Web (WWW) and high speed computer networks, the paradigm for personal computer usage has dramatically shifted. In the past, users would primarily use their personal computers to run programs, and store and manipulate data that was located on their local hard-drive. Only rarely would users store or manipulate data located on a network-accessible drive, or run a program that was provided as a network service, and even then, such programs and data were usually restricted to a local area network.

Today, more and more users are storing more and more data on remote data servers, and using remotely provided web-based applications (e.g., SaaS or Software as a Service programs) to manipulate and organize that data. For example, many users today store their personal email and contact information, and even pictures, videos, and music archives on remote servers, and access that data using third party applications that are provided through and controlled by a web-browser.

Cloud computing is a style of computing in which computing resources such as application programs and file storage are remotely provided over the Internet, typically through a web browser. Many web browsers are capable of running applications (e.g., Java applets), which can themselves be application programming interfaces (“API's”) to more sophisticated applications running on remote servers. In the cloud computing paradigm, a web browser interfaces with and controls an application program that is running on a remote server (or in a network “cloud”). Through the browser, the user can create, edit, save and delete files on the remote server via the remote application program.

Due to this shift in computer usage, today's computer users are unlikely to want or need many of the features and functions provided by modern operating systems. These users do not need to worry about file structures on their computing devices or organizing or backing up their data, because much of their data is stored, organized and backed up for them on the cloud. Such users do not need to worry about loading and updating software, because most of the software they use is provided to them when needed as a cloud-based service. Instead, today's computer users are more interested in quickly logging onto their computer, launching a web browser, and accessing data and programs of interest to them, which are becoming more and more readily accessible through the WWW.

### SUMMARY

In a first general aspect, an example computer-implemented method for facilitating remote administration of a first computing device may include receiving, by a second computing device, an administrator name and a username for a user account for a cloud-based computing service, the user account being assigned to a user of the first computing device. The example method may also include transmitting, from the second computing device to a server, the username for the user account and the administrator name. The example method may further include receiving, by the second computing device, a control panel transmitted from the server, the control panel accepting inputs to change user preferences for the user account and system settings for the first computing device. The example method may also further include receiving, by the second computing device, an input from the control panel to change at least a user preference for the user account and transmitting, from the second computing device to the server, the changed user preference.

In a second general aspect, an example computer-implemented method for facilitating remote administration of a first computing device may include receiving, by a server from a second computing device, an administrator name and a username for a user account for a cloud-based computing service, the user account being assigned to a user of the first computing device. The example method may also include authenticating, by the server, the administrator name. The example method may further include transmitting a control panel from the server to the second computing device, the control panel accepting inputs to change user preferences for the user account and system settings for the first computing device. The example method may still further include receiving, by the server from the second computing device, a change to the user preferences for the user account and updating, by the server, a database record associated with the user account based on the received change.

In a third general aspect, an example computer-implemented method for facilitating remote administration of a first computing device may include receiving, by a second computing device, an administrator name and a username for a user account for a cloud-based computing service, the user account being assigned to a user of the first computing device. The example method may further include transmitting, from the second computing device to a server, the received username for the user account and the administrator name. The example method may also include receiving, by the second computing device, a control panel transmitted from the server, the control panel accepting inputs to change user preferences for the user account and system settings for the first computing device. The example method may still further include receiving, by the second computing device, an input from the control panel to change at least a system setting for the first computing device and transmitting, from the second computing device to the server, the changed system setting for the first computing device.

In a fourth general aspect, an example computer-implemented method for facilitating remote administration of a first computing device may include receiving, by a server from a second computing device, an administrator name, a device ID for the first computing device, and a username for a user account for a cloud-based computing service, the user account being assigned to a user of the first computing device. The example method may also include authenticating, by the server, the administrator name. The example method may still further include transmitting a control panel from the server to the second computing device, the control panel accepting inputs to change user preferences for the user account and system settings for the first computing device. The example method may also include receiving, by the server from the second computing device, a change to the system settings for the first computing device and updating, by the server, a database record associated with the device ID of the first computing device based on the received change.

In a fifth general aspect, an example computer-implemented method for facilitating remote administration of a first computing device and a second computing device may include receiving, by a third computing device, an administrator name and a username for a user account for a cloud-based computing service, the user account being assigned to a user of the first computing device and the second computing device. The example method may further include transmitting, from the third computing device to a server, the received username for the user account and the administrator name. The example method may also include receiving, by the third computing device, a control panel transmitted from the server, the control panel accepting inputs to change user preferences for the user account, system settings for the first computing device and system settings for the second computing device. The example method may still further include receiving, by the third computing device, an input from the control panel to change at least one of a user preference for the user account, a system setting for the first computing device and a system setting for the second computing device. The example method may also include transmitting, from the third computing device to the server, the changes to the user preferences for the user account, the system settings for the first computing device and the system settings for the second computing device.

In a sixth general aspect, an example computer-implemented method for facilitating remote administration of a first computing device may include receiving, by a server from a third computing device, an administrator name and a username for a user account for a cloud-based computing service, the user account being assigned to a user of the first computing device and the second computing device. The example method may also include authenticating, by the server, the administrator name. The example method may still further include transmitting a control panel from the server to the third computing device, the control panel accepting inputs to change user preferences for the user account, system settings for the first computing device and system settings for the second computing device. The example method may also include receiving, by the server from the third computing device, one or more changes to at least one of the user preferences for the user account, the system settings for the first computing device and the system settings for the second computing device. The example method may yet further include updating, by the server, based on the one or more changes, one or more database records associated with at least one of the user account, the first user computing device and the second user computing device.

In a seventh general aspect, a machine-readable storage medium has instructions stored thereon. The instructions, when executed, provide for implementing an example method for facilitating remote administration of a first computing device. The example method may include receiving, by a second computing device, an administrator name and a username for a user account for a cloud-based computing service, the user account being assigned to a user of the first computing device. The example method may also include transmitting, from the second computing device to a server, the username for the user account and the administrator name. The example method may further include receiving, by the second computing device, a control panel transmitted from the server, the control panel accepting inputs to change user preferences for the user account and system settings for the first computing device. The example method may also further include receiving, by the second computing device, an input from the control panel to change at least a user preference for the user account and transmitting, from the second computing device to the server, the changed user preference.

In an eighth general aspect, a machine-readable storage medium has instructions stored thereon. The instructions, when executed, provide for implementing an example method for facilitating remote administration of a first computing device. The example method may include receiving, by a server from a second computing device, an administrator name and a username for a user account for a cloud-based computing service, the user account being assigned to a user of the first computing device. The example method may also include authenticating, by the server, the administrator name. The example method may further include transmitting a control panel from the server to the second computing device, the control panel accepting inputs to change user preferences for the user account and system settings for the first computing device. The example method may still further include receiving, by the server from the second computing device, a change to the user preferences for the user account and updating, by the server, a database record associated with the user account based on the received change.

In a ninth general aspect, a machine-readable storage medium has instructions stored thereon. The instructions, when executed, provide for implementing an example method for facilitating remote administration of a first computing device. The example method may include receiving, by a second computing device, an administrator name and a username for a user account for a cloud-based computing service, the user account being assigned to a user of the first computing device. The example method may further include transmitting, from the second computing device to a server, the received username for the user account and the administrator name. The example method may also include receiving, by the second computing device, a control panel transmitted from the server, the control panel accepting inputs to change user preferences for the user account and system settings for the first computing device. The example method may still further include receiving, by the second computing device, an input from the control panel to change at least a system setting for the first computing device and transmitting, from the second computing device to the server, the changed system setting for the first computing device.

In a tenth general aspect, a machine-readable storage medium has instructions stored thereon. The instructions, when executed, provide for implementing an example method for facilitating remote administration of a first computing device. The example method may include receiving, by a server from a second computing device, an administrator name, a device ID for the first computing device, and a username for a user account for a cloud-based computing service, the user account being assigned to a user of the first computing device. The example method may also include authenticating, by the server, the administrator name. The example method may still further include transmitting a control panel from the server to the second computing device, the control panel accepting inputs to change user preferences for the user account and system settings for the first computing device. The example method may also include receiving, by the server from the second computing device, a change to the system settings for the first computing device and updating, by the server, a database record associated with the device ID of the first computing device based on the received change.

In an eleventh general aspect, a machine-readable storage medium has instructions stored thereon. The instructions, when executed, provide for implementing an example method for facilitating remote administration of a first computing device and a second computing device. The example method may include receiving, by a third computing device, an administrator name and a username for a user account for a cloud-based computing service, the user account being assigned to a user of the first computing device and the second computing device. The example method may further include transmitting, from the third computing device to a server, the received username for the user account and the administrator name. The example method may also include receiving, by the third computing device, a control panel transmitted from the server, the control panel accepting inputs to change user preferences for the user account, system settings for the first computing device and system settings for the second computing device. The example method may still further include receiving, by the third computing device, an input from the control panel to change at least one of a user preference for the user account, a system setting for the first computing device and a system setting for the second computing device. The example method may also include transmitting, from the third computing device to the server, the changes to the user preferences for the user account, the system settings for the first computing device and the system settings for the second computing device.

In a twelfth general aspect, a machine-readable storage medium has instructions stored thereon. The instructions, when executed, provide for implementing an example method for facilitating remote administration of a first computing device and a second computing device. The example method may include receiving, by a server from a third computing device, an administrator name and a username for a user account for a cloud-based computing service, the user account being assigned to a user of the first computing device and the second computing device. The example method may also include authenticating, by the server, the administrator name. The example method may still further include transmitting a control panel from the server to the third computing device, the control panel accepting inputs to change user preferences for the user account, system settings for the first computing device and system settings for the second computing device. The example method may also include receiving, by the server from the third computing device, one or more changes to at least one of the user preferences for the user account, the system settings for the first computing device and the system settings for the second computing device. The example method may yet further include updating, by the server, based on the one or more changes, one or more database records associated with at least one of the user account, the first user computing device and the second user computing device.

In a thirteenth general aspect, an example computing system may be configured to implement an example method for facilitating remote administration of a user computing device. The example computing system may be configured to receive an administrator name and a username for a user account for a cloud-based computing service, the user account being assigned to a user of the user computing device. The example computing system may also be configured to transmit, to a server, the username for the user account and the administrator name. The example computing system may be further configured to receive a control panel transmitted from the server, the control panel accepting inputs to change user preferences for the user account and system settings for the user computing device. The example computing device may also be further configured to receive an input from the control panel to change at least a user preference for the user account and transmit, to the server, the changed user preference.

In a fourteenth general aspect, an example server may be configured to facilitate remote administration of a first computing device. The example server may be configured to receive, from a second computing device, an administrator name and a username for a user account for a cloud-based computing service, the user account being assigned to a user of the first computing device. The example server may also be configured to authenticate the administrator name. The example server may be further configured to transmit a control panel from the server to the second computing device, the control panel accepting inputs to change user preferences for the user account and system settings for the first computing device. The example server may be still further configured to receive, from the second computing device, a change to the user preferences for the user account and update a database record associated with the user account based on the received change.

In a fifteenth general aspect, an example computing system may be configured to facilitate remote administration of a user computing device. The example computing system may be configured to receive an administrator name and a username for a user account for a cloud-based computing service, the user account being assigned to a user of the user computing device. The example computing system may be further configured to transmit, to a server, the received username for the user account and the administrator name. The example computing system may also be configured to receive a control panel transmitted from the server, the control panel accepting inputs to change user preferences for the user account and system settings for the user computing device. The example computing device may be still further configured to receive an input from the control panel to change at least a system setting for the user computing device and transmit, to the server, the changed system setting for the user computing device.

In a sixteenth general aspect, an example server may be configured to facilitate remote administration of a first computing device. The example server may be configured to receive, from a second computing device, an administrator name, a device ID for the first computing device, and a username for a user account for a cloud-based computing service, the user account being assigned to a user of the first computing device. The example server may also be configured to authenticate the administrator name. The example server may be still further configured to transmit a control panel from the server to the second computing device, the control panel accepting inputs to change user preferences for the user account and system settings for the first computing device. The example server may also be configured to receive, from the second computing device, a change to the system settings for the first computing device and update a database record associated with the device ID of the first computing device based on the received change.

In a seventeenth general aspect, an example computing system may be configured to facilitate remote administration of a first user computing device and a second user computing device. The example computing device may be configured to receive an administrator name and a username for a user account for a cloud-based computing service, the user account being assigned to a user of the first user computing device and the second user computing device. The example computing device may be further configured to transmit, to a server, the received username for the user account and the administrator name. The example computing device may also be configured to receive a control panel transmitted from the server, the control panel accepting inputs to change user preferences for the user account, system settings for the first user computing device and system settings for the second user computing device. The example computing device may be still further configured to receive an input from the control panel to change at least one of a user preference for the user account, a system setting for the first user computing device and a system setting for the second user computing device. The example computing device may also be configure to transmit, to the server, the changes to the user preferences for the user account, the system settings for the first user computing device and the system settings for the second user computing device.

In an eighteenth general aspect an example server may be configured to facilitate remote administration of a first computing device and a second computing device. The example server may be configured to, receive, from a third computing device, an administrator name and a username for a user account for a cloud-based computing service, the user account being assigned to a user of the first computing device and the second computing device. The example server may also be configured to authenticate the administrator name. The example server may be still further configured to transmit a control panel to the third computing device, the control panel accepting inputs to change user preferences for the user account, system settings for the first computing device and system settings for the second computing device. The example server may also be configured to receive, from the third computing device, one or more changes to at least one of the user preferences for the user account, the system settings for the first computing device and the system settings for the second computing device. The example server may be yet further configured to update, based on the one or more changes, one or more database records associated with at least one of the user account, the first user computing device and the second user computing device.

### BRIEF DESCRIPTION OF THE DRAWINGS

FIG. 1 is a block diagram illustrating a computing network in accordance with an example embodiment.

FIG. 2 is a block diagram illustrating a control panel in accordance with an example embodiment.

FIG. 3 is a block diagram illustrating another computing network in accordance with an example embodiment.

FIG. 4 is a diagram illustrating a database record that may be used to facilitate remote administration in accordance with an example embodiment.

FIG. 5 is a flowchart illustrating a method for remote administration in accordance with an example embodiment.

FIG. 6 is a flowchart illustrating a method for authenticating a remote administrator in accordance with an example embodiment.

FIG. 7 is a flowchart illustrating another method for remote administration in accordance with an example embodiment.

FIG. 8 is a flowchart illustrating another method for authenticating a remote administrator in accordance with an example embodiment.

FIG. 9 is a flowchart illustrating another method for remote administration in accordance with an example embodiment.

FIG. 10 is a flowchart illustrating another method for remote administration in accordance with an example embodiment.

FIG. 11 shows an example of a computing device and a mobile computing device that can be used to implement the techniques described herein.

Like reference symbols in the various drawings indicate like elements.

### DETAILED DESCRIPTION

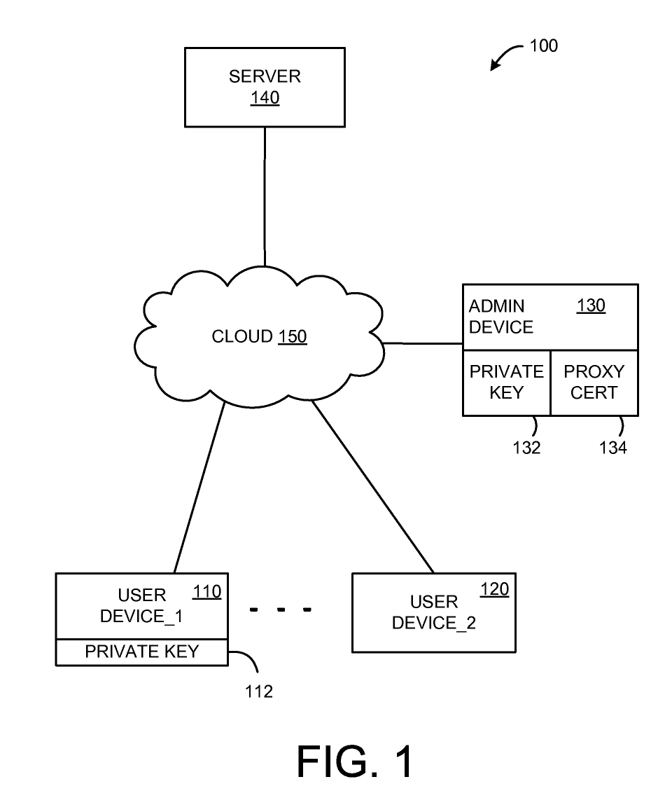

FIG. 1 is a block diagram illustrating a computing network 100 in accordance with an example embodiment. The network 100 may be used to implement the techniques for remote administration of cloud based computing devices and delegation of access rights for such cloud-based computing devices, such as the approaches described herein. Using such techniques, a user may grant another person the ability to remotely manage (e.g., over a network cloud) preferences for a cloud-based computing account assigned to the user, as well as change system settings for one or more computing devices that the user may use to access his or her cloud-based computing account. Using the techniques described herein, a user may also grant others the right to access (e.g., log into) his or her computing devices using respective username/password pairs, for example.

As shown in FIG. 1 the network 100 includes multiple user computing devices 110-120 that a user may use to access cloud-based computing services. In the network 100, such cloud-based computing services may be provided by a server 140 over a network cloud 150. As shown in FIG. 1, the user device 110 includes a user's private key 112. The private key 112 may be used by a user when granting administrative privileges to others to manage his or her cloud-based computing account and system settings for the cloud-based computing devices 110 and 120, such as using the approaches described herein. While not explicitly shown in FIG. 1, the private key 112 may also be included on device 120 as well. As indicated in FIG. 1, the network 100 may include additional user devices. Further, the techniques described herein may also be used in network configurations that include only a single user device, e.g., the device 110.

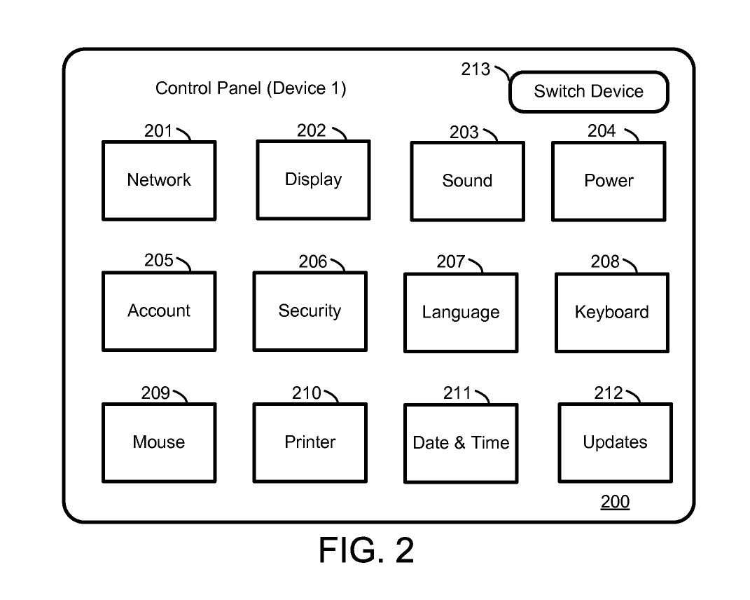

The network 100 also includes an administrator computing device 130. The administrator device 130 may be used, for example, by an authorized administrator to manage account preferences and system settings for a user of the computing devices 110 and 120. The administrator device 130 may simply be another user's cloud based computing device, where the user of computing devices 110 and 120 has granted the other user administrator rights. In this embodiment, the administrator device 130 may access the server 140 via the network cloud 150, in order to carry out cloud-based remote administration for the user's account and computing devices. The server 140 may provide information to the administrator device 130 to facilitate such remote administration. For instance, the server 140 may provide the administrator device 130 with a control panel interface that an administrator can use to change user preferences for a user's cloud-based computing account and to change system settings for the user's computing devices 110 and 120. An example of such a control panel is illustrated in FIG. 2 and described in further detail below.

As is also shown in FIG. 1, the administrator device 130 may include an administrator's private key 132, which the administrator device 130 may use in a process of authenticating the administrator on the server 140 to perform remote administration tasks. As is also shown in FIG. 1, the administrator device 130 may include a proxy certificate 134 that may be used to authenticate the administrator on the server 140 to perform remote administration tasks. In an example embodiment, the proxy certificate 134 may be generated by a user of the computing devices 110 and 120, such as using the user's private key 112, and/or may be issued in accordance with the X.509 digital certificate standard.

In such approaches, the server 140 may store public keys corresponding with the user's private key 112 and the administrator's private key 132. The server 140 may use those public keys when authenticating an administrator. For instance, the administrator device 130 may send the proxy certificate 134 to the server 140 as part of a request to perform remote administration task for the user. The server 140 may then use the user's public key half (that corresponds with the private key 112) to verify the proxy certificate 134 was generated using the private key 112. If the proxy certificate 134 is successfully verified, the administrator is then challenged by the server 140 to demonstrate possession of private key 132. In other embodiments, data sent to the server 140 from the administrator device 130 during remote administration may be encrypted with the administrator's private key 132, which the server 140 may decrypt using the corresponding public key half of the administrator's private key 132. Successful decryption by the server 140 may act as authentication of the remote administrator. In one embodiment, the administrator private key 132 could be used to encrypt the proxy certificate 134, or may be used to encrypt other data that is sent as part of the process of performing remote administration tasks.

FIG. 2 is a block diagram illustrating a control panel 200 in accordance with an example embodiment. The control panel 200 may be used in the network 100 of FIG. 1. Therefore, for purpose of illustration, the control panel 200 will be described with further reference to FIG. 1. As was indicated above, the control panel 200 may be used to perform remote administration tasks using the administrator device 130. For instance, the server may send the control panel 200 to the administrator device 130, e.g., for display as a browser-based interface. An administrator may then use the control panel 200 to make changes to a user's cloud-based account preferences and/or system setting for the user's computing devices 110 and 120. The administrator device 130 may then send a change request including the changes to the server 140. The server 140 may (e.g., after authenticating the administrator) make the changes in one or more database records corresponding with the user's cloud-based computing account and/or the user's computing devices 110 and 120.

As indicated above, the control panel 200 of FIG. 2 may be used to set system settings for one or more computing devices and also set user account preferences for a user's cloud-based computing account. System settings, for example, may refer to settings that are specific to a particular computer, regardless of who is using that computer. Such settings would include things like network connections and preferences, and user account and access rights. In one approach, system settings can only be applied to a computer by the owner of the computer or by an authorized remote administrator, such as by using the control panel 200.

In contrast to system settings, user preferences (or user account preferences) are settings that are specific to a particular user, regardless of what computer the user is logged into. For instance, user preferences for a user may be applied when a user logs into a computer that is owned by another user. User preferences may include such things as keyboard and mouse settings, favorite applications and websites, and music playlists. In one implementation, as noted above, the control panel 200 may be designed as a web-based, browser application, which can store user preferences and respective system setting in local files on the computing devices 110 and 120 and/or in a cloud-based file on the server 140. In one implementation, the system settings and user preferences are stored in one or more database records on the server 140.

As shown in FIG. 2, in one implementation, the control panel 200 includes a Network button 201, a Display button 202, a Sound button 203, a Power button 204, an Accounts button 205, a Security button 206, a Language button 207, a Keyboard button 208, a Mouse button 209, a Printer button 210, a Date and Time button 211 and an Updates button 212. The control panel 200 also includes a Switch Device button 213, which may allow a user or remote administrator to select which of the computing devices 110 and 120 to change system settings for. As indicated above, the user account preference are associated with the user's cloud-based computing account and are not specific to a particular computing device.

In the control panel 200, the Network button 201 may allow a user or remote administrator (collectively “administrator” hereafter) to setup a network connection and make configuration changes for a given computing device. The display button 202 may allow an administrator to select display settings such as screen resolution and color management preferences. The Sound button 203 may allow an administrator to setup and configure audio input and output devices, including adjusting volume and equalization. The Power button 204 may allow an administrator to control power management settings. The Accounts button 205 may allow an administrator to setup and control user accounts. The Security button 206 may allow an administrator to setup and configure access rights and other security system settings such as firewalls, spam filters, and virus protection. The Language button 207 may allow an administrator to configure a computing device for regional language settings. The Keyboard button 208 may allow an administrator to setup keyboard layouts and settings such as the functionality of control keys. The Mouse button 209 may allow an administrator to setup mouse user preferences such as sensitivity and single/double click parameters. The Printer button 210 may allow an administrator to setup and configure printers. The Date and Time button 211 may allow an administrator to select time zones and change the date and time. The Updates button 212 may allow an administrator to configure auto update parameters such as the frequency with which auto updates are received or processed, or whether system reboots are done automatically or at scheduled times after an auto update is received.

The buttons shown in FIG. 2 are given as examples of buttons that may be included in a user interface tool (e.g., the control panel 200) through which an administrator can edit system settings and user preferences. Other user interface tools (e.g., drop down lists, slider bars, text input fields, etc.) could also be used.

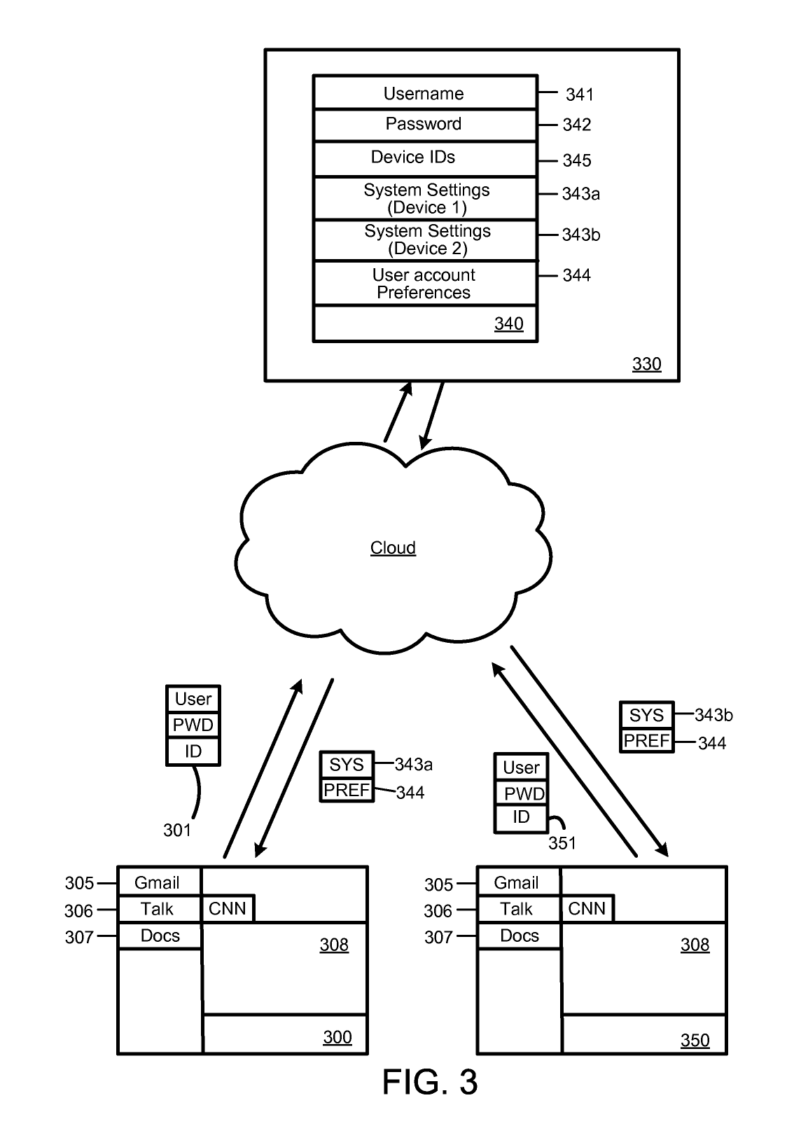

FIG. 3 is a block diagram illustrating another computing network 300 in accordance with an example embodiment. The network 300 is similar in configuration to the network 100, though an administrator device is not shown in FIG. 3. It will be appreciated that the network 300 may include an administrator device in like fashion as the administrator device 130 shown in FIG. 1, and that such an administrator device could be used to facilitate remote administration of a user's cloud-based computing account preferences and system settings for the user's computing devices.

As shown in FIG. 3, the network 300 includes two computing devices 300 and 350. In the network 300, the computing devices 300 and 350 may access a cloud-based server 330 offering a cloud-based service. FIG. 3 also illustrates examples of information that may be exchanged between the computer platforms 300 and 350 and the cloud based server 330. In this example, both the computing devices 300 and 350 are owned by a single user. In other embodiments, the computing devices 300 and 350 may have different owners. In the latter situation, the information exchanged between the server 330 and a computing device that is not owned by a logged in user may be different than that shown in FIG. 3. For instance, if the computing device 350 is not owned by a logged in user, the server 330 may not provide system settings to the computing device because, as discussed above, system settings may be associated with a particular computer that is owned by a user. In this example, if the computing device 350 is not owned by a user that is logged in, the server 330 would not have a record of that computing device associated with the user's account and, therefore, would not have any associated system settings to provide for the computing device 350.

In the example embodiment of FIG. 3, where both the computing devices 300 and 350 are owned by a single user, the user may supply authorization credentials to either the computing device 300 or 350. Those credentials may then be used to log in or authenticate the user to one or more cloud-based services or accounts. For this example, it will be assumed that the user provides his or her authorization credentials to the computing device 300. In this situation, if the computing device 300 stores the user's system settings and user account preferences on the remote server 330, the computer 300 may send authentication information 301 to the server 330 to authenticate the user. In one implementation, the authentication information includes a username, password, and a unique ID that is used to uniquely identify the computer 300. In some implementations, this authentication information may be encrypted prior to being sent to the remote server 330.

As shown in FIG. 3, the server 330 may include a database record 340 that stores information such as a username 341, a password 342, system settings 343a (for computing device 300) and 343b (for computing device 350), user preferences 344, and a list of device IDs 345 for a given user. In and example embodiment, the server 330 may include a database that comprises a plurality of such records for respective users. It will be appreciated that the arrangement of the database record 340 is given by way of example and other arrangements are possible. For instance, the server 330 may store separate database records 340 for each computing device owned by a particular user. Of course, still other approaches are possible.

After receiving the information 301 from the computer 300, the server 330 may authenticate the information 301 in a two step process. First, the server 330 may determine whether the user has a valid account by looking for the username and password sent by the computing device 300 in the database records 340. If the server 330 cannot determine that the user has a valid account, either because it cannot find the username in the database records 340, or because the password associated with the username in the database records 340 does not match the password sent by computer 300, the server 330 can send information to the computing device 300 either denying the user access to computing device 300, or granting the user only limited access to computer 300 and/or the server 330. If the user is granted only limited access to computer 300 and/or the server 330, the computer 300 may allow the user to only use certain default applications, such as a web browser.

If, however, the server 330 confirms the information 301 sent by the computing device 300, the server 330 may then determine whether the user is accessing his or her account from the user's own computer 300 or from another computer that is not owned by the user (e.g., is not associated with the user's cloud-based computing account). The server 330 may make this determination by, for example, comparing a device ID sent by the computing device 300 to the list of unique IDs 345 that are associated with the user's account in the database record 340. If the device ID sent by the computer 300 matches one of the device IDs in the list of device IDs 345, the server 330 would then know the user is accessing his or her account from his or her own computing device 300.

In this situation, the server 330 may then send the computing device 300 the user's system settings 343a for the computing device 300 and the user's account preferences 344. Upon receiving the system settings 343a and the user preferences 344, the computing device 300 may then apply them. For example, the computing device 300 may apply the user preferences 344 to launch one or more applications, such as Google Gmail 305, Google Talk 306 and Google Docs 307 applications. The computing device 300 may also load a web browser 308 with the CNN homepage in accordance with the user preferences 344. Additionally, the computing device 300 may apply the system settings 343a to configure the computing system 300 in accordance with those settings

In the above example, a remote administrator may have made changes to the user preferences 344 and/or the system settings 343a since the user has last logged into the computer. In this situation, when the user next logs into the computer 300, such as in the fashion described above, the user preferences 344 and the system setting 343a, including any changes made by the administrator, would be applied by the computing device 300.

In like fashion as with the computing device 300, the user may alternatively log into the computing device 350 by providing a username and password. Once the user has provided a username and password to the computing device 350, the computing device 350 may then send authentication information 351 to the server 330 to authenticate the user. The authentication information 351 may include the provided password and username, as well as a unique device ID for the computing system 350. The server 330 may then perform the authentication process described above. For purposes of brevity, the specifics of that process will not be described in detail again. However, if the authentication information 351 sent to the server 330 is determined to match the username 341 and the password 342, the server 330 would provide the system settings 343b to the computing system 350 based on the unique ID included in the authentication information 351. After receiving the system settings 343b and the user preferences 344, the computing system 350 may then apply them, including any changes made by a remote administrator since the last time the user logged into the computing device 350.

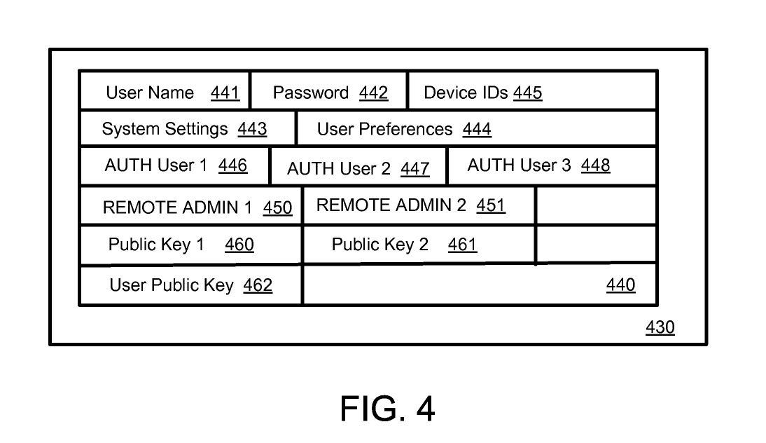

FIG. 4 is a diagram illustrating a database record 440 included on a server 430 that may be used to facilitate remote administration in accordance with an example embodiment. In one implementation, the database record 430 may be used in combination with the database record 340 shown in FIG. 3. For instance, the information in the database records 340 and 440 may be merged into a single database record. Of course, there are a number of ways that the information in the database records 340 and 440 could be stored on a server and/or computing system.

As shown in FIG. 4, the database record 440 can store information such as a user's username 441, a user's password 442 and the device IDs 445 for one or more computing devices that are owned by the user. In addition, the database record 440 can store a user's system settings 443 (for one or more cloud-based computing devices owned by the user) and the user's account preferences 444 (for a cloud-based computing account of the user). As explained above with respect to FIG. 3, this information may used to allow the user to log into and configure a computing device, which may or may not be owned by the user.

As shown in FIG. 4, the database record 440 can also store a list of authorized users 446-448 who are permitted to access a computing device that they do not own, and a list of remote administrators 450-451 who are permitted to remotely administer a user's computing devices. The list of authorized users 446-448 can be used to directly grant or restrict access by other users to a computing device. The lists of authorized users 446-448 and remote administrators 450-451 may act as access control lists for, respectively, controlling access to a computing device or performing remote administration tasks. In such an approach, an authorized user (e.g., a user listed in an authorized user access control list) may access a corresponding computing device by providing his or her credentials to the computing device and/or a server, such as in the manners discussed above. Likewise, an authorized remote administrator (e.g., a user listed in a remote administrator access control list) may be permitted to perform remote administration tasks by providing his or credentials (username/password) to a sever along with a username of the user who has authorized the administrator and/or a device ID of the computing system the administrator is authorized to remotely administrate.

Additionally, the database record 440 may include a public key 460 that corresponds with a private key of a user identified as the remote administrator 450, a public key 461 that corresponds with a private key of a user identified as the remote administrator 451 and a user public key 462 that corresponds with a private key of the user with the username 441. These public keys, as was discussed above and is discussed further below, may be used to authenticate remote administrators when performing remote administration tasks. For instance, the public keys 460-462 may be used by the server 430 to decrypt data that was previously encrypted using the respective private keys, or to encrypt data that may be sent, e.g., to an administrator computing device, for decryption as part of an authentication process.

As was previously discussed, the remote administrators 450 and 451 may be persons who do not own a given computing device, but who are nonetheless granted the ability to change the computing device's owner's user preferences 444 and system settings 443. For example, an owner (with the username 441) of a first cloud-based computing device may list the owner of a second cloud-based computing device as a remote administrator 450. The user 441 may also provide the private keys 460-462 to the server 430. In other embodiments, the server 430 may automatically obtain the public keys 460-462, such as from emails, user accounts, or other sources associated with the user 441 and/or the remote administrators 450 and 451.

In an example embodiment, once the server 430 has authenticated a remote administrator, e.g., the remote administrator 450, the server 430 would allow the remote administrator 450 to access and modify both the system settings 443 and the user preferences 444 of the owner 441's computing device(s) and user account. The server 430 may authenticate the remote administrator using an access control list or other authentication process, such as those described herein.

As previously discussed, such remote administration may be facilitated, for example, by providing the remote administrator 450's computing device a control panel for the user's account and computing device(s), such as the control panel 200 shown in FIG. 2, even though the remote administrator 450 is logged onto his or her own computer, such as the administrator device 130 shown in FIG. 1. The server 430 may then update the system settings 443 and user preferences 444 in the database record 440 based on any changes made by the remote administrator 450 through the control panel 200. Such changes may be applied on a user's computing device the next time the user logs into the corresponding device. Providing such remote administration capabilities allows less sophisticated users to easily receive help from trusted friends and family to setup and use their computer platforms optimized for cloud-based computing.

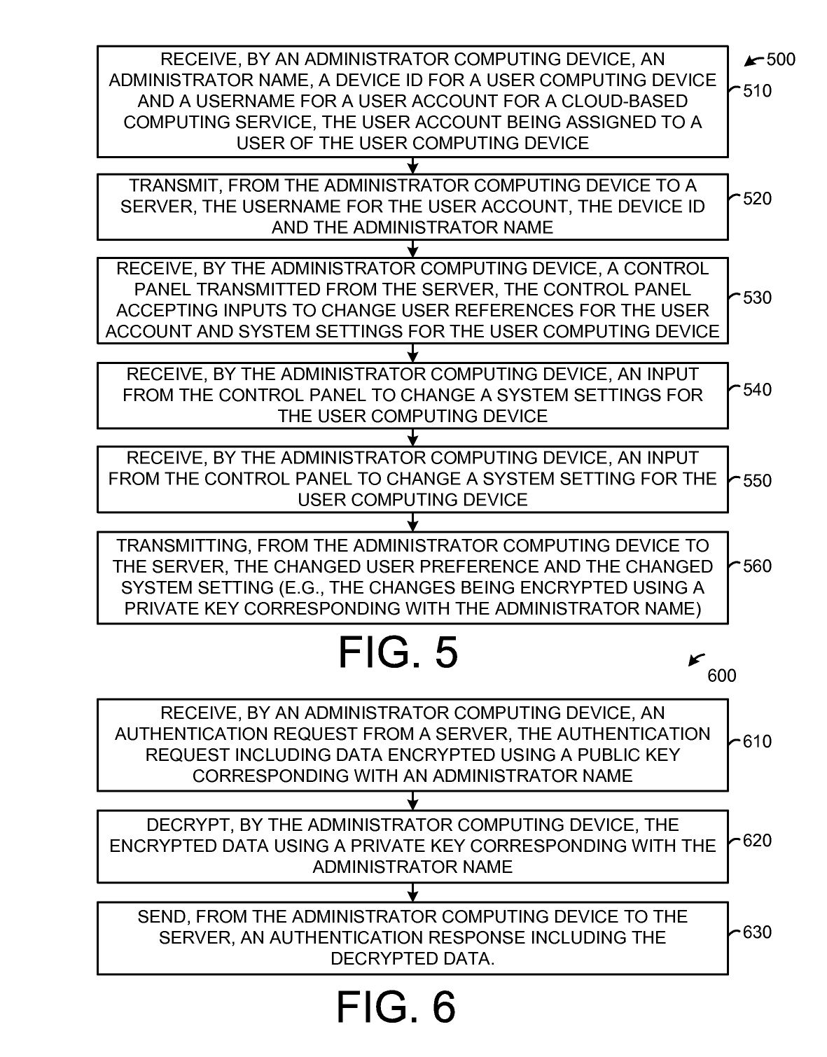

FIGS. 5-10 are flowcharts illustrating methods that may be used to facilitate remote administration of a user's cloud-based computing account and/or cloud based computing devices. The methods illustrated in FIGS. 5-10 may be implemented using the techniques described above with respect to FIGS. 1-4. Of course, the methods of FIGS. 5-10 may be implemented in other fashions as well. Furthermore, the approaches illustrated in FIGS. 5-10 may be implemented in conjunction with one another. In other approaches, some operations of FIGS. 5-10 may be omitted, while other operations may be added.

FIG. 5 is a flowchart illustrating a method 500 for facilitating remote administration of a user computing device in accordance with an example embodiment. The method 500 includes, at block 510, receiving, by an administrator computing device, an administrator name and a username for a user account for a cloud-based computing service, where the user account is assigned to a user of the user computing device. At block 520, the method 500 includes transmitting, from the administrator computing device to a server, the username for the user account and the administrator name. At block 530, the method 500 includes receiving, by the administrator computing device, a control panel (such as the control panel 200) transmitted from the server, the control panel accepting inputs to change user preferences for the user account and system settings for the user's computing device. At block 540, the method 500 includes receiving, by the administrator computing device, an input from the control panel to change a user preference for the user account. At block 550, the method 500 includes receiving, by the administrator computing device, an input from the control panel to change a system setting for the user computing device. The method 500 further includes, at block 560, transmitting, from the administrator computing device to the server, the changed user preference and the changed system setting. Other approaches may include only changing a system setting or only changing a user preference.

As indicated at block 560 of the method 500, in one embodiment, the administrator device may encrypt the changes to the user preferences and the system settings (e.g., using a private key of the administrator) prior to sending the changes to the server. Such an approach may be used to authenticate the administrator and provide additional security to the user for which remote administration is performed. In such an approach, the server may decrypt the change request(s) using a public key that corresponds with the administrator's private key, where the public key is stored in the sever, as was previously discussed. If the changes are successfully decrypted, this provides authentication of the identity of the remote administrator by demonstrating that the private key of the administrator was used to encrypt the changes to the user preferences and/or the system settings.

FIG. 6 is a flowchart illustrating a method 600 for authenticating a remote administrator in accordance with an example embodiment. In this example, the authentication process illustrated in FIG. 6 may be performed in conjunction with method 500 shown in FIG. 5 and occur prior to the server sending the control panel to the administrator device.

The method 600, at block 610, includes receiving, by an administrator computing device, an authentication request from a server. The authentication request may include data that was encrypted using a public key corresponding with the administrator's name. The method 600, at block 610, further includes decrypting, by the administrator computing device, the encrypted data using a private key corresponding with the administrator name. At block 630, the method 600 includes sending, from the administrator computing device to the server, an authentication response including the decrypted data. Using such an approach, if the decrypted data sent to the sever matches the data that was originally encrypted by the server, this match server to authenticate the administrator by demonstrating that the data encrypted using the administrator's public key was properly decrypted in response to the authentication request.

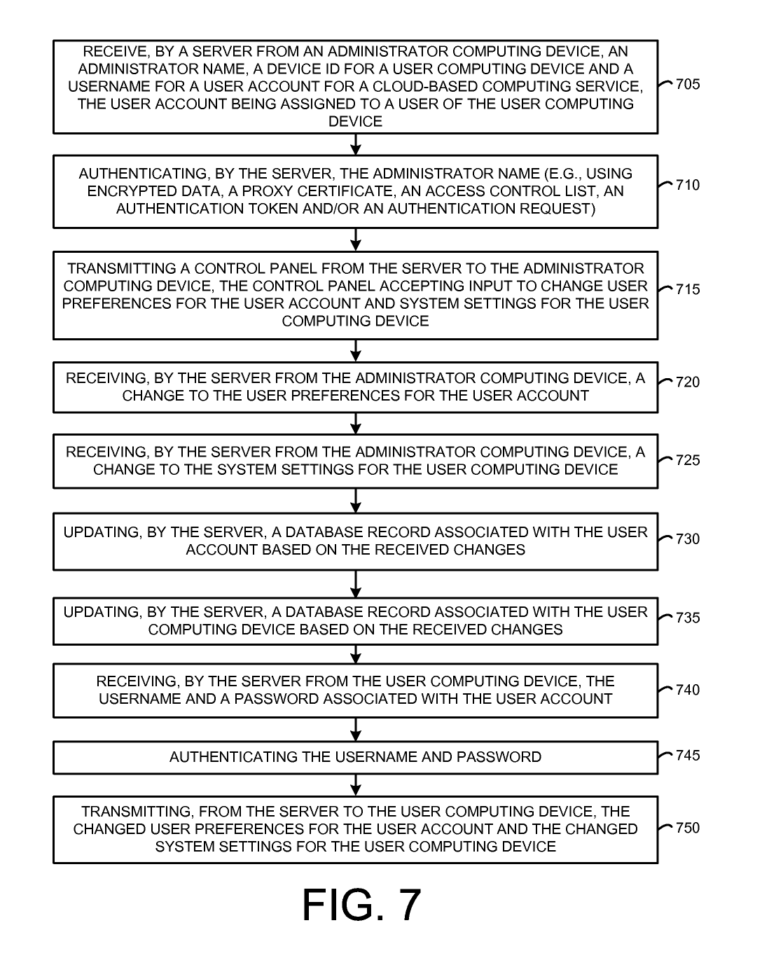

FIG. 7 is a flowchart illustrating another method 700 for facilitating remote administration in accordance with an example embodiment. The method 700 includes, at block 705, receiving, by a server from an administrator computing device, an administrator name, a device ID for a user computing device and a username for a user account for a cloud-based computing service, where the user account is assigned to a user of the user computing device. At block 710, the method 700 includes authenticating the administrator.

A number of approaches are possible for performing such administrator authentication, such as those discussed herein. For instance, decrypted data may be used to authenticate the administrator, where public key encryption is used as part of the authentication handshake. In other embodiments, the user may provide a proxy certificate to the administrator. The administrator may then send that proxy certificate to the server when performing remote administration tasks. In such an approach, the proxy certificate may serve to authenticate the administrator. In other embodiments, the user may provide the administrator with an authentication token (which may be encrypted using the user's private key). The administrator may then provide the authentication token to the server in order to authenticate his or her identity. The server may use the user's private key to decrypt the token. If the token is decrypted properly, the server may authenticate the administrator. In still other embodiments, the server may use an access control list or may initiate an authentication handshake process, such as previously described, to authenticate the administrator.

The method 700 further includes, at block 715, transmitting a control panel from the server to the administrator computing device, where the control panel accepts inputs to change user preferences for the user account and system settings for the user computing device, such as described above with respect to FIG. 2. At block 720, the method 700 includes receiving, by the server from the administrator computing device, a change to the user preferences for the user account. At block 725, the method 700 includes receiving, from the administrator computing device, a change to a system setting for the user computing device (for the computing device corresponding with the device ID provided at block 705). The method 700 also includes, at block 730, updating, by the server, a database record associated with the user account based on the received change and, at block 735, updating a database record associated with the device ID to reflect the change to the system setting.

In the method 700, changes to the user preferences and/or system settings may be applied to a user's computing device in the following manner. At block 740, the method 700 includes receiving, by the server from the user computing device, the username and a password associated with the user account. At block 745, the method 700 includes authenticating the username and password, such as in the fashions discussed above. At block 750, the method 700 further includes transmitting, from the server to the user computing device, the changed user preferences for the user account and the changed system settings for the user computing device. The user computing device may then apply the changes, such as in the fashions described herein.

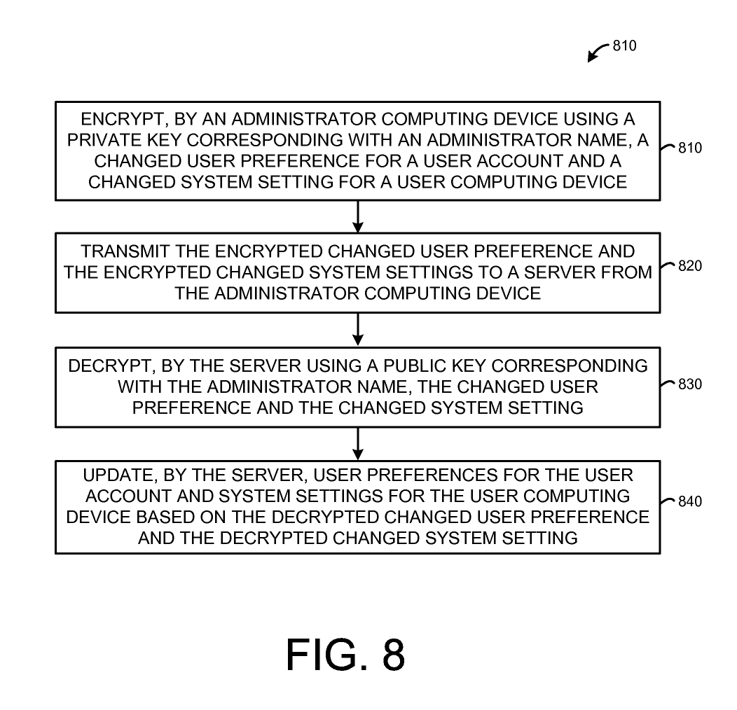

FIG. 8 is a flowchart illustrating another method 800 for authenticating a remote administrator in accordance with an example embodiment. The method 800 includes, at block 810, encrypting, by an administrator computing device using an administrator private key, a changed user preference and a changed system setting. In other embodiments, only a system setting or only a user preference may be encrypted. At block 820, the method 800 includes transmitting the encrypted changed user preference and the encrypted changed system setting to a server. At block 830, the method 800 includes decrypting, by the server using a public key corresponding with the administrator's name, the changed user preference and the changed user setting. At block 840, the method 800 includes updating, by the server in a one or more database records, user preferences for a user account based on the changed user preference and system settings for a user computing device based on the changed system setting. In such an approach, proper decryption of the changed user preference and the changed user setting may serve to authenticate the administrator. If the changes do not properly decrypt, the server would not authenticate the administrator and no changes to a user's database record(s) would be made.

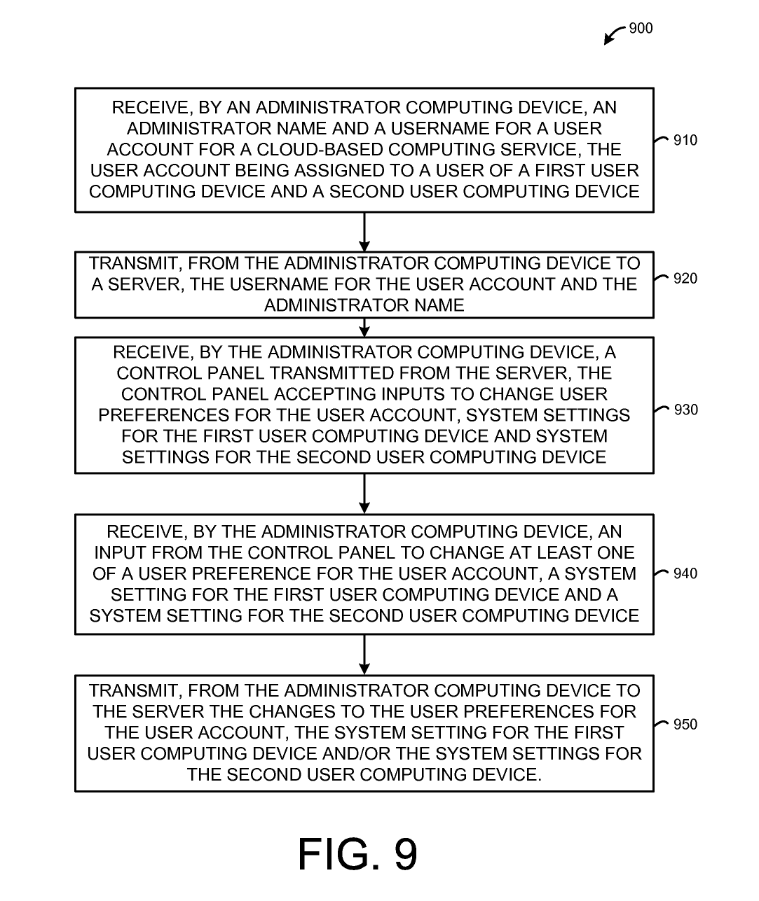

FIG. 9 is a flowchart illustrating another method 900 for facilitating remote administration in accordance with an example embodiment. The method 900 may be used to facilitate remote administration of a user's cloud-based computing account, a first user computing device owned by the user and a second user computing device owned by the user.

The method 900 includes, at block 910, receiving, by an administrator computing device, an administrator name and a username for a user account for a cloud-based computing service, where the user account is assigned to a user of the first user computing device and the second user computing device. At block 920, the method 900 includes transmitting, from the administrator computing device to a server, the received username for the user account and the administrator name. The method 900 further includes, at block 930, receiving, by the administrator computing device, a control panel transmitted from the server, the control panel accepting inputs to change user preferences for the user account, system settings for the first user computing device and system settings for the second user computing device. At block 940, the method 900 includes receiving, by the administrator computing device, an input from the control panel to change at least one of a user preference for the user account, a system setting for the first user computing device and a system setting for the second user computing device. At block 950, the method 900 includes transmitting, from the administrator computing device to the server, the changes to the user preferences for the user account, the system settings for the first user computing device and the system settings for the second user computing device.

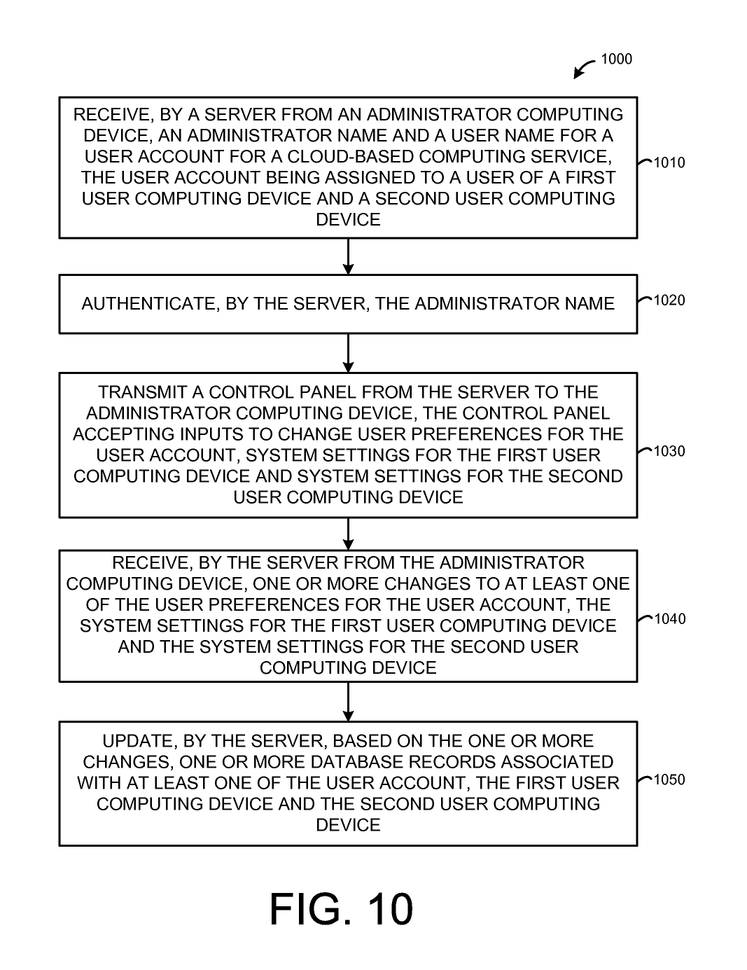

FIG. 10 is a flowchart illustrating yet another method 1000 for facilitating remote administration in accordance with an example embodiment. The method 1000 may be used to facilitate remote administration of a user's cloud-based computing account, a first user computing device owned by the user and a second user computing device owned by the user.

The method 1000 includes, at block 1010, receiving, by a server from an administrator computing device, an administrator name and a username for a user account for a cloud-based computing service, where the user account is assigned to a user of the first user computing device and the second user computing device. At block 1020, the method 1000 includes authenticating, by the server, the administrator name. Such authentication may be done using a number of techniques, such as those described herein. The method 1000 also includes, at block 1030, transmitting a control panel from the server to the administrator computing device, the control panel accepting inputs to change user preferences for the user account, system settings for the first computing device and system settings for the second computing device. At block 1040, the method 1000 includes receiving, by the server from the administrator computing device, one or more changes to at least one of the user preferences for the user account, the system settings for the first user computing device and the system settings for the second user computing device. At block 1050, the method 1000 includes updating, by the server, based on the one or more changes, one or more database records associated with at least one of the user account, the first user computing device and the second user computing device.

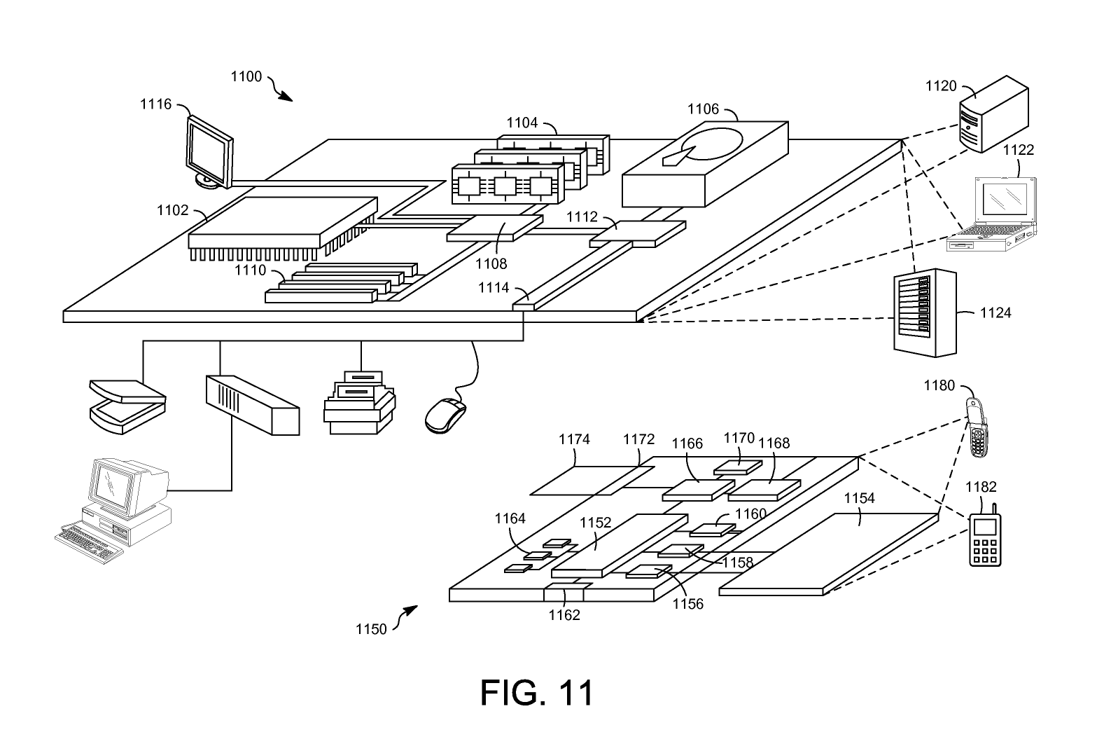

FIG. 11 is a diagram that shows an example of a generic computer device 1100 and a generic mobile computer device 1150, which may be used with the techniques described here. Computing device 1100 is intended to represent various forms of digital computers, such as laptops, desktops, workstations, personal digital assistants, servers, blade servers, mainframes, and other appropriate computers. Computing device 1150 is intended to represent various forms of mobile devices, such as personal digital assistants, cellular telephones, smart phones, and other similar computing devices. The components shown here, their connections and relationships, and their functions, are meant to be exemplary only, and are not meant to limit implementations of the inventions described and/or claimed in this document.

Computing device 1100 includes a processor 1102, memory 1104, a storage device 1106, a high-speed interface 1108 connecting to memory 1104 and high-speed expansion ports 1110, and a low speed interface 1112 connecting to low speed bus 1114 and storage device 1106. Each of the components 1102, 1104, 1106, 1108, 1110, and 1112, are interconnected using various busses, and may be mounted on a common motherboard or in other manners as appropriate. The processor 1102 can process instructions for execution within the computing device 1100, including instructions stored in the memory 1104 or on the storage device 1106 to display graphical information for a GUI on an external input/output device, such as display 1116 coupled to high speed interface 1108. In other implementations, multiple processors and/or multiple buses may be used, as appropriate, along with multiple memories and types of memory. Also, multiple computing devices 1100 may be connected, with each device providing portions of the necessary operations (e.g., as a server bank, a group of blade servers, or a multi-processor system).

The memory 1104 stores information within the computing device 1100. In one implementation, the memory 1104 is a volatile memory unit or units. In another implementation, the memory 1104 is a non-volatile memory unit or units. The memory 1104 may also be another form of computer-readable medium, such as a magnetic or optical disk.

The storage device 1106 is capable of providing mass storage for the computing device 1100. In one implementation, the storage device 1106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 1104, the storage device 1106, or memory on processor 1102.

The high speed controller 1108 manages bandwidth-intensive operations for the computing device 1100, while the low speed controller 1112 manages lower bandwidth-intensive operations. Such allocation of functions is exemplary only. In one implementation, the high-speed controller 1108 is coupled to memory 1104, display 1116 (e.g., through a graphics processor or accelerator), and to high-speed expansion ports 1110, which may accept various expansion cards (not shown). In the implementation, low-speed controller 1112 is coupled to storage device 1106 and low-speed expansion port 1114. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 1100 may be implemented in a number of different forms, as shown in the figure. For example, it may be implemented as a standard server 1120, or multiple times in a group of such servers. It may also be implemented as part of a rack server system 1124. In addition, it may be implemented in a personal computer such as a laptop computer 1122. Alternatively, components from computing device 1100 may be combined with other components in a mobile device (not shown), such as device 1150. Each of such devices may contain one or more of computing device 1100, 1150, and an entire system may be made up of multiple computing devices 1100, 1150 communicating with each other.

Computing device 1150 includes a processor 1152, memory 1164, an input/output device such as a display 1154, a communication interface 1166, and a transceiver 1168, among other components. The device 1150 may also be provided with a storage device, such as a microdrive or other device, to provide additional storage. Each of the components 1150, 1152, 1164, 1154, 1166, and 1168, are interconnected using various buses, and several of the components may be mounted on a common motherboard or in other manners as appropriate.

The processor 1152 can execute instructions within the computing device 1150, including instructions stored in the memory 1164. The processor may be implemented as a chipset of chips that include separate and multiple analog and digital processors. The processor may provide, for example, for coordination of the other components of the device 1150, such as control of user interfaces, applications run by device 1150, and wireless communication by device 1150.

Processor 1152 may communicate with a user through control interface 1158 and display interface 1156 coupled to a display 1154. The display 1154 may be, for example, a TFT LCD (Thin-Film-Transistor Liquid Crystal Display) or an OLED (Organic Light Emitting Diode) display, or other appropriate display technology. The display interface 1156 may comprise appropriate circuitry for driving the display 1154 to present graphical and other information to a user. The control interface 1158 may receive commands from a user and convert them for submission to the processor 1152. In addition, an external interface 1162 may be provide in communication with processor 1152, so as to enable near area communication of device 1150 with other devices. External interface 1162 may provide, for example, for wired communication in some implementations, or for wireless communication in other implementations, and multiple interfaces may also be used.

The memory 1164 stores information within the computing device 1150. The memory 1164 can be implemented as one or more of a computer-readable medium or media, a volatile memory unit or units, or a non-volatile memory unit or units. Expansion memory 1174 may also be provided and connected to device 1150 through expansion interface 1172, which may include, for example, a SIMM (Single In Line Memory Module) card interface. Such expansion memory 1174 may provide extra storage space for device 1150, or may also store applications or other information for device 1150. Specifically, expansion memory 1174 may include instructions to carry out or supplement the processes described above, and may include secure information also. Thus, for example, expansion memory 1174 may be provide as a security module for device 1150, and may be programmed with instructions that permit secure use of device 1150. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 1164, expansion memory 1174, or memory on processor 1152, which may be received, for example, over transceiver 1168 or external interface 1162.

Device 1150 may communicate wirelessly through communication interface 1166, which may include digital signal processing circuitry where necessary. Communication interface 1166 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 1168. In addition, short-range communication may occur, such as using a Bluetooth, WiFi, or other such transceiver (not shown). In addition, GPS (Global Positioning System) receiver module 1170 may provide additional navigation- and location-related wireless data to device 1150, which may be used as appropriate by applications running on device 1150.

Device 1150 may also communicate audibly using audio codec 1160, which may receive spoken information from a user and convert it to usable digital information. Audio codec 1160 may likewise generate audible sound for a user, such as through a speaker, e.g., in a handset of device 1150. Such sound may include sound from voice telephone calls, may include recorded sound (e.g., voice messages, music files, etc.) and may also include sound generated by applications operating on device 1150.

The computing device 1150 may be implemented in a number of different forms, as shown in the figure. For example, it may be implemented as a cellular telephone 1180. It may also be implemented as part of a smart phone 1182, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments have been described. Nevertheless, it will be understood that various modifications may be made without departing from the spirit and scope of the invention.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Furthermore, techniques shown in the various figures may be implemented in conjunction with one another, as appropriate. Accordingly, other embodiments are within the scope of the following claims.

What is claimed is:

1. A computer-implemented method for facilitating remote administration of a first computing device, the method comprising:
receiving, by a second computing device, an administrator name and a username for a user account for a cloud-based computing service, the user account being assigned to a user of the first computing device;
transmitting, from the second computing device to a server, the username for the user account and the administrator name;
receiving, by the second computing device, a control panel transmitted from the server, the control panel accepting inputs to change user preferences for the user account and system settings for the first computing device;
receiving, by the second computing device, an input from the control panel to change at least a user preference for the user account; and
transmitting, from the second computing device to the server, the changed user preference.

2. The computer-implemented method of claim 1, further comprising:
receiving, by the second computing device, a device ID for the first computing device; and
transmitting, from the second computing device to the server, the device ID.

3. The computer-implemented method of claim 2, further comprising:
receiving, by the second computing device, an input from the control panel to change a system setting for the first computing device; and
transmitting, from the second computing device to the server, the changed system setting.

4. The computer-implemented method of claim 3, further comprising, prior to transmitting the changed user preference and the changed system setting, encrypting the changed user preference and the changed system setting using a private key corresponding with the administrator name,
wherein:
transmitting the changed user preference comprises transmitting the encrypted changed user preference; and
transmitting the changed system setting comprises transmitting the encrypted changed system setting.

5. The computer-implemented method of claim 1, further comprising, prior to receiving the control panel:
receiving, by the second computing device, an authentication request from the server, the authentication request including data encrypted using a public key corresponding with the administrator name;
decrypting, by the second computing device, the encrypted data using a private key corresponding with the administrator name; and
sending, from the second computing device to the server, an authentication response including the decrypted data.

6. The computer-implemented method of claim 1, further comprising transmitting, from the second computing device to the server, data encrypted using a private key corresponding with the administrator name, the encrypted data being transmitted with the administrator name and the username.

7. The computer-implemented method of claim 1, further comprising transmitting, from the second computing device to the server, a proxy certificate corresponding with the username, the proxy certificate being transmitted with the administrator name and the username.

8. The computer-implemented method of claim 1, further comprising transmitting, from the second computing device to the server, an authentication token corresponding with the username, the authentication token being transmitted with the administrator name and the username.

9. The computer-implemented method of claim 8, wherein the authentication token is encrypted using a private key corresponding with the username.

10. The computer-implemented method of claim 1, further comprising, prior to transmitting the changed user preference, encrypting the changed user preference using a private key corresponding with the administrator name,
wherein transmitting the changed user preference comprises transmitting the encrypted changed user preference.

11. A computer-implemented method for facilitating remote administration of a first computing device, the method comprising:
receiving, by a server from a second computing device, an administrator name and a username for a user account for a cloud-based computing service, the user account being assigned to a user of the first computing device;
authenticating, by the server, the administrator name;
transmitting a control panel from the server to the second computing device, the control panel accepting inputs to change user preferences for the user account and system settings for the first computing device;
receiving, by the server from the second computing device, a change to the user preferences for the user account; and
updating, by the server, a database record associated with the user account based on the received change.

12. The computer-implemented method of claim 11, further comprising, receiving, by the server from the second computing device, a device ID for the first computing device.

13. The computer-implemented method of claim 12, further comprising:
receiving, from the second computing device, a change to a system setting for the first computing device; and
updating a database record associated with the device ID to reflect the change to the system setting.

14. The computer-implemented method of claim 13, further comprising:
receiving, by the server from the first computing device, the username and a password associated with the user account;
authenticating the username and password; and
transmitting, from the server to the first computing device, the changed user preferences for the user account and the changed system settings for the first computing device.

15. The computer-implemented method of claim 14, wherein:
the change to the system settings for the first computing device is encrypted using a private key corresponding with the administrator name, and
authenticating the administrator name comprises decrypting the change to the system settings for the first computing device using a public key corresponding with the administrator name.

16. The computer-implemented method of claim 11, further comprising:
receiving, by the server from the first computing device, the username and a password associated with the user account;
authenticating the username and password; and
transmitting, from the server to the first computing device, the changed user preferences for the user account.

17. The computer-implemented method of claim 11, further comprising:
receiving, from the second computing device, a proxy certificate associated with the username,
wherein authenticating the administrator name comprises authenticating the administrator name using the proxy certificate.

18. The computer-implemented method of claim 11, further comprising:
receiving an authentication token corresponding with the username,
wherein authenticating the administrator name comprises authenticating the administrator name using the authentication token.

19. The computer-implemented method of claim 11, wherein authenticating the administrator name comprises locating the administrator name in an access control list corresponding with the user account.

20. The computer-implemented method of claim 11, wherein:
the change to the user preferences is encrypted using a private key corresponding with the administrator name, and
authenticating the administrator name comprises decrypting the change to the user preferences using a public key corresponding with the administrator name.

21. A method for facilitating remote administration of a first computing device, the method comprising:
receiving, by a second computing device, an administrator name and a username for a user account for a cloud-based computing service, the user account being assigned to a user of the first computing device;
transmitting, from the second computing device to a server, the received username for the user account and the administrator name;
receiving, by the second computing device, a control panel transmitted from the server, the control panel accepting inputs to change user preferences for the user account and system settings for the first computing device;
receiving, by the second computing device, an input from the control panel to change at least a system setting for the first computing device; and
transmitting, from the second computing device to the server, the changed system setting for the first computing device.

22. A computer-implemented method for facilitating remote administration of a first computing device, comprising:
receiving, by a server from a second computing device, an administrator name, a device ID for the first computing device, and a username for a user account for a cloud-based computing service, the user account being assigned to a user of the first computing device;
authenticating, by the server, the administrator name;
transmitting a control panel from the server to the second computing device, the control panel accepting inputs to change user preferences for the user account and system settings for the first computing device;
receiving, by the server from the second computing device, a change to the system settings for the first computing device; and
updating, by the server, a database record associated with the device ID of the first computing device based on the received change.

23. A computer-implemented method for facilitating remote administration of a first computing device and a second computing device, the method comprising:
receiving, by a third computing device, an administrator name and a username for a user account for a cloud-based computing service, the user account being assigned to a user of the first computing device and the second computing device;
transmitting, from the third computing device to a server, the received username for the user account and the administrator name;
receiving, by the third computing device, a control panel transmitted from the server, the control panel accepting inputs to change user preferences for the user account, system settings for the first computing device and system settings for the second computing device;
receiving, by the third computing device, an input from the control panel to change at least one of a user preference for the user account, a system setting for the first computing device and a system setting for the second computing device; and
transmitting, from the third computing device to the server, the changes to the user preferences for the user account, the system settings for the first computing device and the system settings for the second computing device.

24. A computer-implemented method for facilitating remote administration of a first computing device and a second computing device, comprising:
receiving, by a server from a third computing device, an administrator name and a username for a user account for a cloud-based computing service, the user account being assigned to a user of the first computing device and the second computing device;
authenticating, by the server, the administrator name;
transmitting a control panel from the server to the third computing device, the control panel accepting inputs to change user preferences for the user account, system settings for the first computing device and system settings for the second computing device;
receiving, by the server from the third computing device, one or more changes to at least one of the user preferences for the user account, the system settings for the first computing device and the system settings for the second computing device; and
updating, by the server, based on the one or more changes, one or more database records associated with at least one of the user account, the first user computing device and the second user computing device.

25. The computer-implemented method of claim 24, further comprising:
receiving, by the server from the first computing device, the username, a password associated with the user account and a device ID of the first user computing device;
authenticating the username and password; and
transmitting, from the server to the first computing device, changes to the user preferences for the user account and the system settings for the first user computing device in the one or more database records.

26. The computer-implemented method of claim 24, further comprising:
receiving, by the server from the second user computing device, the username, a password associated with the user account and a device ID of the second user computing device;
authenticating the username and password; and
transmitting, from the server to the second computing device, changes to the user preferences for the user account and the system settings for the second computing device in the one or more database records.
